(19) United States
(12) Patent Application Publication
(10) Pub. No.: US 2025/0264889 A1
(43) Pub. Date: Aug. 21, 2025

(54) CONTROL METHOD AND CONTROL DEVICE OF USING 2 ROTATING OBLIQUELY TRUNCATED CYLINDER

(71) Applicant: KOREA ATOMIC ENERGY RESEARCH INSTITUTE, Daejeon (KR)

(72) Inventor: Sang-Jin CHO, Daejeon (KR)

(73) Assignee: KOREA ATOMIC ENERGY RESEARCH INSTITUTE, Daejeon (KR)

(21) Appl. No.: 19/047,836

(22) Filed: Feb. 7, 2025

(30) Foreign Application Priority Data
Feb. 16, 2024 (KR) 10-2024-0022878
Apr. 24, 2024 (KR) 10-2024-0054461

(51) Int. Cl. G05D 3/10

(52) U.S. Cl. CPC G05D 3/10

(57) ABSTRACT

Provided is a control method and a control device of the rotating cylinder, by inducing a trigonometric function calculation between X-axis and Y-axis inclinations of a rotating cylinder and declination angles formed by a first wheel and a second wheel constituting the rotating cylinder.

### CROSS-REFERENCE TO RELATED APPLICATION(S)

This application claims benefit of priority to Korean Patent Application Nos. 10-2024-0022878 filed on Feb. 16, 2024 and 10-2024-0054461 filed on Apr. 24, 2024, in the Korean Intellectual Property Office, the disclosures of which are incorporated herein by reference in its entirety.

### BACKGROUND

### 1. Field

The present disclosure relates to a control method and a control device of a rotating cylinder for aligning horizontality of two obliquely cut rotating cylinders or precisely controlling a target angle thereof.

### 2. Description of Related Art

Precise parallel alignment and leveling of high-tech and industrial manufacturing equipment is critical to product quality and yield. In the case of existing parallel alignment, there is a disadvantage in that it takes a relatively long period of time to adjust heights by repeatedly measuring and adjusting a product while pushing up a ball at four corners (or three points of support) thereof. In addition, although existing parallel alignment is easy for the parallel alignment of a two-axis goniometer, it has the disadvantage that it cannot be used for aligning high-load machines or equipment because it is used for relatively light equipment.

A balance stage disclosed in patent document 1 suggests a method for enabling precise operation of an industrial robot arm, or the like by independently rotating two rotating plates. The balance stage can adjust a declination angle of an object and implement a tilting operation through the rotation of an inner rail and an outer rail. The balance stage may align parallelism by measuring X, Y, and Z coordinates using a three-dimensional measuring device for precision control, but the present disclosure is to provide a control method and a control device for achieving a desired horizontal alignment or angle adjustment by measuring an inclination of a rotating cylinder composed of two rotating disks, such as the balance stage.
(Patent Document 1) KR 10-2463976 B1

### SUMMARY

The present disclosure is to provide a control method and a control device for two obliquely cut rotating cylinders, that can measure X-axis and Y-axis inclinations of a rotating cylinder composed of two rotating first and second wheels and declination angles of the first and second wheels, and calculate rotation angles of the first and second wheels according to the inclinations and the declination angles by applying trigonometric function calculations.

An aspect of the present disclosure is to provide the following control method and control device for a rotating cylinder.

According to aspect of the present disclosure, provided is a control method of a rotating cylinder, the control method including: a first calculation operation of setting a virtual X-axis and a virtual Y-axis, which are orthogonal coordinate systems, on a rotating cylinder including a first wheel and a second wheel, which are disposed so that inclined surfaces forming a declination angle with respect to each of base surfaces are in contact with each other, and calculating rotation angles of the first wheel and the second wheel by inputting a target change value of X-axis and Y-axis inclinations of the rotating cylinder, and a first rotation operation of rotating the first wheel by a first rotation angle, which is a rotation angle of the first wheel calculated in the first calculation operation, around a first rotation axis directed from a base surface of the first wheel to a center of rotation, and rotating the second wheel by a second rotation angle, which is a rotation angle of the second wheel, around a second rotation axis directed from a base surface of the second wheel to a center of rotation, wherein the centers of rotation of the first and second wheels are the same.

In an embodiment, in the first calculation operation, a relationship between the change value of the X-axis inclination of the rotating cylinder and the change value of the Y-axis inclination of the rotating cylinder may be applied to a trigonometric function.

In an embodiment, the change value of the X-axis inclination of the rotating cylinder may be the sum of the change value of the X-axis inclination of the first wheel and the change value of the X-axis inclination of the second wheel, and the change value of the Y-axis inclination of the rotating cylinder may be the sum of the change value of the Y-axis inclination of the first wheel and the change value of the Y-axis inclination of the second wheel.

In an embodiment, in the first calculation operation, the first rotation angle and the second rotation angle according to the change value of the X-axis inclination and the change value of the Y-axis inclination of the rotating cylinder may be calculated by the following mathematical formulas (1) and (2).

$$C 1 = ω1 \cdot cos {θ}_{1} + ω2 \cdot cos {θ}_{2} \qquad Mathematical formula ( 1 )$$

$$C 2 = ω1 \cdot sin {θ}_{1} + ω2 \cdot sin {θ}_{2} \qquad Mathematical formula ( 2 )$$

where θ₁ refers to a first rotation angle, θ₂ refers to a second rotation angle, ω1 refers to a declination angle of a first wheel, ω2 refers to a declination angle of a second wheel, C₁ refers to a change value of X-axis inclination, and C₂ refers to a change value of Y-axis inclination.

In an embodiment, in the first calculation operation, a range of the change value of the X-axis inclination and the change value of the Y-axis inclination of the rotating cylinder may be calculated by the following mathematical formula (3).

$${( ω 1 - ω 2 )}^{2} \leq C {1}^{2} + C {2}^{2} \leq {( ω1 + ω2 )}^{2} \qquad Mathematical formula ( 3 )$$

where w1 refers to a declination angle of a first wheel, w2 refers to a declination angle of a second wheel, C1 refers to a change value of X-axis inclination, and C2 refers to a change value of Y-axis inclination.

In an embodiment, the first wheel may rotate in one of a clockwise direction or a counterclockwise direction, and the second wheel may rotate in the same direction as the rotation direction of the first wheel.

In an embodiment, in the first rotation operation, the first wheel and the second wheel may be rotated simultaneously, and rotation speeds of the first wheel and the second wheel may be calculated by the following mathematical formula (4).

$${v}_{1} = \frac{{θ}_{1}}{t} , {v}_{2} = \frac{{θ}_{2}}{t} \qquad Mathematical formula ( 4 )$$

where v₁ refers to a rotation speed of a first wheel, v₂ refers to a rotation speed of a second wheel, θ₁ refers to a first rotation angle, θ₂ refers to a second rotation angle, and t refers to a pre-set rotation time.

According to aspect of the present disclosure, provided is a control method of a rotating cylinder, the control method including: a second rotation operation of rotating a first wheel and a second wheel disposed so that inclined surfaces forming a declination angle with respect to each of base surfaces are in contact with each other, rotating the first wheel by a first rotation angle, which is a pre-set rotation angle of the first wheel, around a first rotation axis directed from a base surface of the first wheel to a center of rotation, and rotating the second wheel by a second rotation angle, which is a pre-set rotation angle of the second wheel, around a second rotation axis directed from a base surface of the second wheel to a center of rotation; and a second calculation operation of setting a virtual X-axis and a virtual Y-axis, which are orthogonal coordinate systems, on the rotating cylinder, and calculating change values of X-axis and Y-axis inclinations of the rotating cylinder by inputting the first rotation angle and the second rotation angle, wherein the centers of rotation of the first wheel and the second wheel may be the same.

In an embodiment, in the second calculation operation, a relationship between the change value of the X-axis inclination and the change value of the Y-axis inclination may be applied to a trigonometric function.

In an embodiment, in the second calculation operation, the change value of the X-axis inclination and the change value of the Y-axis inclination according to the pre-set first rotation angle and second rotation angle may be calculated by the following mathematical expressions (1) and (2).

$$C 1 = ω1 \cdot cos {θ}_{1} + ω2 \cdot cos {θ}_{2} \qquad Mathematical formula ( 1 )$$

$$C 2 = ω1 \cdot sin {θ}_{1} + ω2 \cdot sin {θ}_{2} \qquad Mathematical formula ( 2 )$$

where θ₁ refers to a first rotation angle, θ₂ refers to a second rotation angle, ω1 refers to a declination angle of a first wheel, ω2 refers to a declination angle of a second wheel, C1 refers to a change value of X-axis inclination, and C2 refers to a change value of Y-axis inclination.

In an embodiment, in the present disclosure, provided is a control device of a rotating cylinder including a first wheel and a second wheel disposed so that inclined surfaces forming a declination angle with respect to each of base surfaces are in contact with each other, wherein the control device of the rotating cylinder includes a memory storing commands and a processor operating by executing the commands, the processor may set a virtual X-axis and a virtual Y-axis, which are orthogonal coordinate systems, on the rotating cylinder, calculate rotation angles of the first wheel and the second wheel by inputting target change values of X-axis and Y-axis inclinations of the rotating cylinder, rotate the first wheel in a clockwise direction by a first rotation angle, the calculated rotation angle of the first wheel, and rotate the second wheel in a clockwise direction by a second rotation angle, the rotation angle of the second wheel, wherein the centers of rotation of the first wheel and the second wheel may be the same.

In an embodiment, the processor may apply a relationship between the change value of the X-axis inclination and the change value of the Y-axis inclination to a trigonometric function in the process of calculating the rotation angles of the first wheel and the second wheel.

In an embodiment, the processor may calculate the first rotation angle and the second rotation angle using the pre-set change value of the X-axis inclination and the change value of the Y-axis inclination of the rotating cylinder by the following mathematical formulas (1) and (2).

$$C 1 = ω1 \cdot cos {θ}_{1} + ω2 \cdot cos {θ}_{2} \qquad Mathematical formula ( 1 )$$

$$C 2 = ω1 \cdot sin {θ}_{1} + ω2 \cdot sin {θ}_{2} \qquad Mathematical formula ( 2 )$$

where θ₁ refers to a first rotation angle, θ₂ refers to a second rotation angle, ω1 refers to a declination angle of a first wheel, ω2 refers to a declination angle of a second wheel, C1 refers to a change value of X-axis inclination, and C2 refers to a change value of Y-axis inclination.

In an embodiment, the control device of the rotating cylinder may include a first base plate provided on a base surface of the first wheel and a second base plate provided on a base surface of the second wheel, and the first base plate may have an inclination according to the change value of the X-axis inclination and the Y-axis inclination of the rotating cylinder.

In an embodiment, an inclination sensor for measuring X-axis inclination and Y-axis inclination of an object to be detected disposed on the first base plate may be further included, wherein the processor, in the process of inputting the change values of the X-axis and Y-axis inclinations, may input compensation values of the X-axis inclination and Y-axis inclination of the object to be detected measured by the inclination sensor, and may rotate the first wheel and the second wheel by the rotation angles of the first wheel and the second wheel calculated according to the compensation values of the X-axis inclination and Y-axis inclination of the object to be detected.

In an embodiment, the rotating cylinder may have a phase difference of 180° between the first wheel and the second wheel.

### BRIEF DESCRIPTION OF DRAWINGS

The above and other aspects, features, and advantages of the present disclosure will be more clearly understood from the following detailed description, taken in conjunction with the accompanying drawings, in which:

FIGS. 1 and 2 are plan views of a rotating cylinder according to an embodiment of the present disclosure with the same declination angles, viewed in a second direction;

FIGS. 3 and 4 are plan views of a rotating cylinder according to one embodiment of the present disclosure with different declination angles, viewed in a second direction;

FIG. 5 is a schematic perspective view of a rotating cylinder according to an embodiment of the present disclosure;

FIG. 6A is a schematic perspective view illustrating the second wheel rotated 10° in a clockwise direction in a rotating cylinder according to an embodiment of the present disclosure, and FIG. 6B is a schematic perspective view illustrating the first wheel rotated 10° in a clockwise direction in a rotating cylinder according to an embodiment of the present disclosure;

FIG. 7A is a schematic plan view illustrating movement of coordinates when the first wheel rotates counterclockwise by θ₁, and FIG. 7B is a schematic plan view illustrating movement of coordinates when the second wheel rotates counterclockwise by θ₂;

FIG. 8 is a flowchart of a control method of a rotating cylinder according to a first embodiment of the present disclosure;

FIG. 9 is a flowchart of a control method of a rotating cylinder according to a second embodiment of the present disclosure;

FIG. 10 is a block diagram of a computing device that can fully or partially implement a control device of a rotating cylinder according to an embodiment of the present disclosure; and

FIG. 11 is a usage state diagram of a control device of a rotating cylinder according to an embodiment of the present disclosure.

### DETAILED DESCRIPTION

Hereinafter, specific embodiments of the present disclosure will be described with reference to the attached drawings. However, the spirit of the present disclosure is not limited to the presented embodiments, and other regressive inventions or other embodiments included in the spirit of the present disclosure may be easily suggested by a person skilled in the art who understands the spirit of the present disclosure by adding, changing, or deleting other components within the scope of the same spirit, but it will also be said to be included within the scope of the present disclosure.

In addition, throughout the specification, that a component is ‘connected’ with another component includes not only cases in which these components are ‘directly connected’ but also ‘indirectly connected’ through other components. In addition, ‘including’ a certain component means that other components may be further included, rather than excluding other components, unless otherwise stated.

In addition, components having the same function within the same scope of the same idea shown in the drawings of each embodiment are described using the same reference numerals.

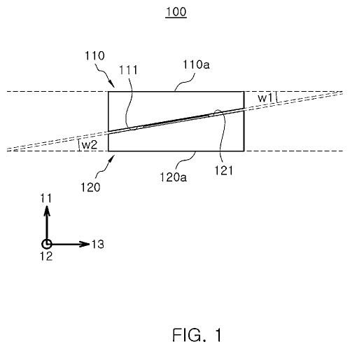

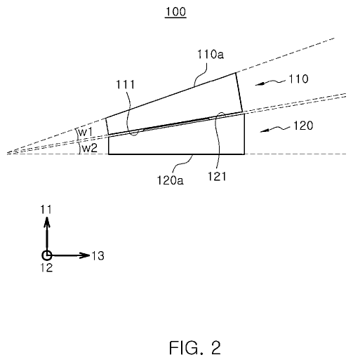

FIGS. 1 to 4 schematically illustrate a plan view of a rotating cylinder 100 according to an embodiment of the present disclosure as viewed in a second direction. More specifically, FIGS. 1 and 2 are plan views of a rotating cylinder 100 according to an embodiment of the present disclosure when declination angles of the first wheel 110 and the second wheel 120 are the same, as viewed in the second direction.

Meanwhile, in the specification of the present disclosure, the rotating cylinder 100 may mean a rotating cylinder including two obliquely cut rotating wheels. Furthermore, in the specification of the present disclosure, a first direction 11 may mean a height direction in the drawing and a direction in which the first wheel 110 and the second wheel 120 are stacked, a second direction 12 and a third direction 13 may mean a direction perpendicular to the first direction 11 and a direction parallel to a horizontal plane, and the second direction 12 and third direction 13 may be directions perpendicular to each other.

The rotating cylinder 100 according to an embodiment of the present disclosure includes a first wheel 100 and a second wheel 120 in which inclined surfaces 111 and 112 forming a declination angle (w) are respectively formed, with respect to a horizontal plane. In this case, the first wheel 110 and the second wheel 120 may be disposed so that each of the inclined surfaces 111 and 112 of the first wheel 110 and the second wheel 120 are in contact with each other, and may have a shape in which surfaces obtained by being obliquely cut are disposed face to face. The inclined surface 111 of the first wheel 110 may form a first declination angle (w1) with a first base surface 110a of the first wheel 110, and the inclined surface 121 of the second wheel 120 may form a second declination angle (w2) with a second base surface 120a of the second wheel 120. In this case, the first wheel 100 and the second wheel 120 may rotate independently, and the centers of rotation of the first wheel 110 and the second wheel 120 may be provided to be the same. That is, the first wheel 110 and the second wheel 120 may have rotation axes 110c and 120c perpendicular to each of the base surfaces 110a and 120a, and the first rotation axis 110c of the first wheel 110 and the second rotation axis 120c of the second wheel 120 may be provided to face the same center of rotation.

As shown in FIGS. 1 and 2, the first declination angle (w1) and the second declination angle (w2) may be equal to each other. In this case, when the rotating cylinder 100 is in a parallel state, the first base surface 110a and the second base surface 120a are parallel to each other and aligned parallel to the horizontal surface, thereby enabling horizontal alignment.

As illustrated in FIG. 1, the rotating cylinder 100 may be provided such that when viewed in the second direction, one end of the first wheel 110 is disposed on one side of the third direction, and one end of the second wheel 120 is disposed on the other side of the third direction. In the specification of the present disclosure, a reference position of the first wheel 110 may be set such that one end thereof is disposed on one side of the third direction, and in this case, a phase of the first wheel 110 may be set to 0°. Conversely, a reference position of the second wheel 120 may be set such that one end thereof, disposed opposite to the one end of the first wheel 110, is disposed on the other side of the third direction, and in this case, the phase of the second wheel 120 may be set to 180°. That is, when the phase difference between the first wheel 110 and the second wheel 120 is 180°, the rotating cylinder 100 may be horizontally aligned, and as shown in FIG. 2, when the phase difference between the first wheel 110 and the second wheel 120 is 0°, the rotating cylinder 100 has an inclination angle equal to the sum of the first declination angle (w1) and the second declination angle (w2).

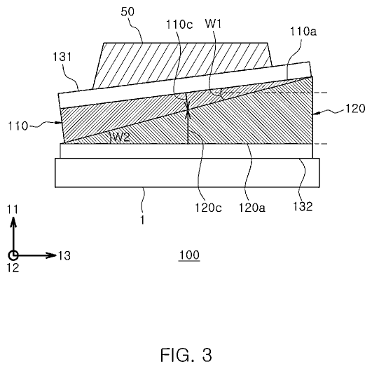

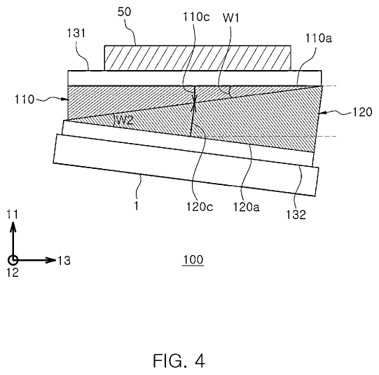

As shown in FIGS. 3 and 4, the rotating cylinder 100 according to an embodiment of the present disclosure may be provided with the different first and second declination angles (w1) and (w2). In addition, the rotating cylinder 100 according to an embodiment of the present disclosure may include a first base plate 131 provided on a base surface 110a of the first wheel 110 and a second base plate 132 provided on a base surface 120a of the second wheel 120. The first and second base plates 131 and 132 may be provided so as not to rotate according to the rotation of the first wheel 110 and the second wheel 120. Accordingly, similar to FIGS. 1 and 2, the first base plate 131 may have a desired inclination according to the rotation of the rotating cylinder 100, so that the X-axis inclination and the Y-axis inclination of the object to be detected 50 disposed on the first base plate 131 may be controlled.

That is, as illustrated in FIG. 3, the rotating cylinder 100 according to an embodiment of the present disclosure may align the horizontality of the object to be detected 50 by using the first wheel 110 and the second wheel 120 having the different first and second declination angles (w1) and (w2) when the inclination of the object to be detected 50 is severe. In addition, as shown in FIG. 4, even when an inclination of a ground 1 is not flat but rather severely inclined, the horizontality of the object to be detected 50 may be aligned using the first wheel 110 and the second wheel 120 having the different first and second declination angles (w1) and (w2).

Therefore, according to an embodiment of the present disclosure, the rotating cylinder 100 may have a different inclination of the first base surface 110a according to the rotation of the first wheel 110 and the second wheel 120. Furthermore, since the rotating cylinder 100 according to an embodiment of the present disclosure may adjust the inclination of the first base surface 110a by the rotation of the first wheel 110 and the second wheel 120 which are in surface contact with each other, so that horizontal alignment of a high-load material may be performed rather than horizontal alignment by point contact, in addition to the horizonal alignment, an angle of an object disposed above the first base surface 110a may be rotated as desired, so it can be applied to robot arms, artificial joints, and the like.

The control method of a rotating cylinder according to an embodiment of the present disclosure recognizes the above-described necessity, and can provide a method of simply and precisely controlling a change value of the inclination of the first base surface 110a which changes accordingly with rotation of the first wheel 110 and the second wheel 120b by deriving the same as a trigonometric function. In this case, the control method of the rotating cylinder according to an embodiment of the present disclosure may be applied equally to cases in which the first declination angle (w1) and the second declination angle (w2) are the same and cases in which the first declination angle (w1) and the second declination angle (w2) are different.

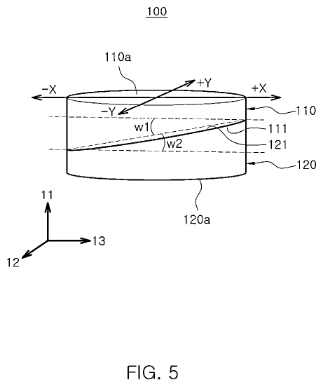

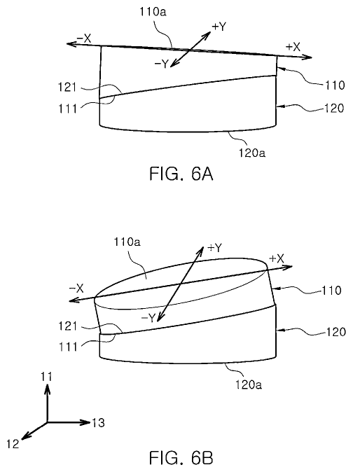

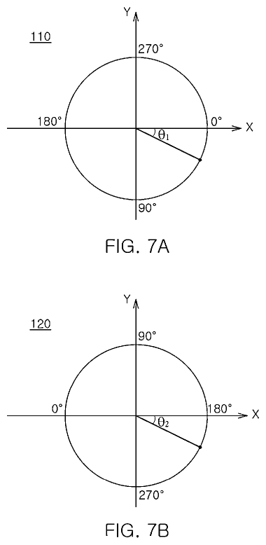

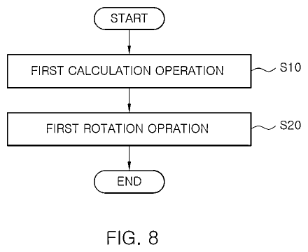

FIGS. 5 to 8 are drawings for explaining a control method of a rotating cylinder according to an embodiment of the present disclosure. More specifically, FIG. 5 is a schematic perspective view of a rotating cylinder according to an embodiment of the present disclosure, FIG. 6 is a drawing illustrating a change in inclination according to a control method of a rotating cylinder according to an embodiment of the present disclosure, FIG. 7 is a schematic plan view as viewed in the first direction to explain a change in an orthogonal coordinate system according to the rotation of the first wheel or the second wheel, and FIG. 8 is a flowchart of a control method of a rotating cylinder according to a first embodiment of the present disclosure. Hereinafter, a control method of a rotating cylinder according to an embodiment of the present disclosure will be described with reference to FIGS. 5 to 8.

As shown in FIG. 5, the control method of the rotating cylinder according to an embodiment of the present disclosure includes a first wheel 110 and a second wheel 120 having inclined surfaces 111 and 121 formed at declination angles (w1 and w2) based on each of base surfaces 110a and 120a, a rotating cylinder 100 disposed so that an inclined surface 111 of the first wheel 110 and an inclined surface 121 of the second wheel 120 are in contact may be controlled, and includes a first calculation operation (S10) and a first rotation operation (S20).

In the first calculation operation (S10), by setting a virtual X-axis and a virtual Y-axis, which are orthogonal coordinate systems for the rotating cylinder 100, and inputting the target change values C1 and C2 of the X-axis and Y-axis inclinations of the rotating cylinder 100, rotation angles θ₁ and θ₂ of the first wheel 110 and the second wheel 120 may be calculated, in the first rotation operation (S20), the first wheel 110 may be rotated in one of the clockwise or counterclockwise direction by a first rotation angle (θ₁), which is the rotation angle of the first wheel 110 calculated in the calculation operation (S10), and the second wheel 120 may be rotated in the same direction as the rotation direction of the first wheel 110 by a second rotation angle (θ₂), the rotation angle of the second wheel 120. Here, the virtual orthogonal coordinate system may be set on the base surface 110a of the first wheel 110 or on the first base plate 131, and the change values of the X-axis and Y-axis inclinations of the rotating cylinder 100 may mean a change value of the first direction 11 of the X-axis and Y-axis of the virtual orthogonal coordinate system.

Assuming that the declination angles (w1 and w2) of the first wheel 110 and the second wheel 120 are the same, when it is desired to change the X-axis and Y-axis inclinations of the rotating cylinder 100 by 2° and 3°, respectively, +2 may be input to the change value C1 of the X-axis inclination, and +3 may be input to the change value C2 of the Y-axis inclination. Accordingly, in the first calculation operation (S10), a first rotation angle (θ₁) of 44.076° according to the input change value C1 of the X-axis inclination, and a second rotation angle (θ₂) of 203.304° according to the input change value C2 of the Y-axis inclination may be calculated.

Meanwhile, assuming that the declination angles (w1 and w2) of the first wheel 110 and the second wheel 120 are different from each other, and that the declination angle (w1) of the first wheel 110 is 5° and the declination angle (w2) of the second wheel 120 is 10°, when it is desired to change the inclinations of the X-axis and Y-axis of the rotating cylinder 100 by 6° and 2°, respectively, 5° may be input to the first declination angle (w1), 10° may be input to the second declination angle (w2), +6 may be input to the change value C1 of the X-axis inclination, and +2 may be input to the change value C2 of the Y-axis inclination. Accordingly, in the first calculation operation (S10), a first rotation angle and a second rotation angle (θ₁ and θ₂) according to the input change values C1 and C2 of the X-axis and Y-axis inclinations may be calculated as (37.9646°, 186.176°) or (136.954°, 285.166°). That is, when the declination angles (w1 and w2) are different from each other, unlike when the declination angles (w1 and w2) are the same, the X-axis and Y-axis inclination change values C1 and C2 of the rotating cylinder 100 may have two values. In this case, the values of the first rotation angle and the second rotation angle (θ₁ and θ₂) may be calculated by the calculation of the mathematical formulas (1) and (2) described below.

Therefore, the control method of the rotating cylinder according to an embodiment of the present disclosure may be changed to have the target X-axis inclination and Y-axis inclination of the rotating cylinder 100 by rotating the first wheel 110 and the second wheel 120 by the first wheel 110 and the second wheel 120 by the first rotation angle (θ₁) and the second rotation angle (θ₂), respectively.

The first calculation operation (S10) may be performed while the first wheel 110 and the second wheel 120 are aligned horizontally. Accordingly, the X-axis of the rotating cylinder 100 may be formed to be extended in a direction parallel to the third direction 13, and Y-axis of the rotating cylinder 100 may be formed to be extended in a direction parallel to the second direction 12, perpendicular to the third direction 13.

In the first rotation operation (S20), the first wheel 110 may be rotated in one of a clockwise or counterclockwise direction around a first rotation axis 110c facing the center of rotation from the base surface of the first wheel 110, and the second wheel 120 may be rotated in the same direction as the rotation direction of the first wheel 110 around a second rotation axis 120c facing the center of rotation from the base surface 120a of the second wheel 120. The first rotation axis 110c and the second rotation axis 120c may be formed to extend in a vertical direction from the center of rotation located on each of the inclined surfaces 111 and 112. Meanwhile, the control method of a rotating cylinder according to an embodiment of the present disclosure may be applied even if the rotation directions of the first wheel 110 and the second wheel 120 are different from each other. Hereinafter, the description is based on the assumption that the rotation directions of the first wheel 110 and the second wheel 120 are the same.

FIG. 6A is a schematic perspective view illustrating the second wheel 120 rotated 10° in a clockwise direction in a rotating cylinder 100 according to an embodiment of the present disclosure, and FIG. 6B is a schematic perspective view illustrating the first wheel 100 rotated 10° in a clockwise direction in a rotating cylinder 100 according to an embodiment of the present disclosure.

As shown in FIG. 6A, when the second wheel 120 rotates 10° clockwise, the X-axis and Y-axis inclinations of the rotating cylinder 100 may have a (−) inclination with respect to the third direction 13. Meanwhile, as shown in FIG. 6B, when the first wheel 110 rotates 10° clockwise, the X-axis and Y-axis inclinations of the rotating cylinder 100 may have a (+) inclination with respect to the third direction 13. That is, according to an embodiment of the present disclosure, the X-axis and Y-axis inclinations of the rotating cylinder 100 may change to (−) or (+) with respect to the third direction 13 as one of the first wheel 110 or the second wheel 120 rotates in the clockwise direction. Meanwhile, in the rotating cylinder 100 according to an embodiment of the present disclosure, when the first wheel 110 and the second wheel 120 are rotated in the same direction by the same angle, the X-axis and Y-axis inclinations of the rotating cylinder 100 can be the same as an initial state thereof. For example, in a horizontally aligned state as shown in FIG. 5, if the first wheel 100 and the second wheel 120 rotate in the clockwise direction by the same angle, the horizontally aligned state may be returned.

In the first calculation operation (S10), the relationship between the change value C1 of the X-axis inclination of the rotating cylinder 100 and the change value C2 of the Y-axis inclination of the rotating cylinder 100 may be applied to a trigonometric function. More specifically, since the X-axis and the Y-axis have a difference of 90°, the change value C1 of the X-axis inclination can apply a Cosine function to the declination angle (w1) of the first wheel 110, and the change value C2 of the Y-axis inclination can apply a Sine function to the declination angle (w2) of the second wheel 120.

FIG. 7 is a schematic plan view viewed in the first direction to explain a change in an orthogonal coordinate system according to the rotation of one of the first wheel 110 or the second wheel 120. More specifically, FIG. 7A is a schematic plan view illustrating movement of coordinates when the first wheel 110 rotates counterclockwise by θ₁, FIG. 7B is a schematic plan view illustrating movement of coordinates when the second wheel 120 rotates counterclockwise by θ₂. In this case, the first wheel 110 and the second wheel 120 are described based on having a phase difference of 180°.

When the first wheel 110 rotates in a counterclockwise direction by θ₁, an X-axis inclination after the rotation may be expressed as ω1 cos θ₁, and a Y-axis inclination after the rotation may be expressed as ω1 sin θ₁. However, when the first wheel 110 rotates in a counterclockwise direction by θ₁, θ₁ has a value between 90° and 180° based on the phase of the first wheel 110, so cos θ₁ has a (+) value. In reality, when the first wheel 110 rotates counterclockwise by θ₁, change values of the X-axis and Y-axis inclinations of the rotating cylinder should have a (+) value, so the change value of the X-axis inclination may be expressed as ω1(+cos θ₁).

Similarly, as shown in FIG. 7B, when the first wheel 110 is fixed and the second wheel 120 rotates counterclockwise by an angle of θ₂, the X-axis and Y-axis may also rotate counterclockwise by an angle of θ₂.

In this case, the change value C1 of the X-axis inclination of the rotating cylinder 100 may be calculated as the sum of the change values of the X-axis inclination of each of the first wheel 110 and the second wheel 120, and the change value C2 of the Y-axis inclination of the rotating cylinder 100 may be calculated as the sum of the change values of the Y-axis inclination of each of the first wheel 110 and the second wheel 120. For example, the change value C1 of the X-axis inclination of the rotating cylinder 100 may be ω1·cos θ₁+ω2·cos θ₂, and the change value C2 of the Y-axis inclination of the rotating cylinder 100 may be ω1·sin θ₁+ω2·sin θ₂.

Therefore, in the first calculation operation (S10) according to an embodiment of the present disclosure, the first rotation angle (θ₁) and the second rotation angle (θ₂) according to the change value C1 of the X-axis inclination and the change value C2 of the Y-axis inclination of the pre-set rotating cylinder may be calculated by the following mathematical formulas (1) and (2). That is, in the first calculation operation (S10), since C1, C2, w1, and w2 are constants, the first rotation angle (θ₁) and the second rotation angle (θ₂) may be calculated by the following mathematical formulas (1) and (2).

$$C 1 = ω1 \cdot cos {θ}_{1} + ω2 \cdot cos {θ}_{2} \qquad Mathematical formula ( 1 )$$

$$C 2 = ω1 \cdot sin {θ}_{1} + ω2 \cdot sin {θ}_{2} \qquad Mathematical formula ( 2 )$$

where θ₁ refers to a first rotation angle, θ₂ refers to a second rotation angle, ω1 refers to a declination angle of a first wheel, ω2 refers to a declination angle of a second wheel, C1 refers to a change value of X-axis inclination, and C2: refers to a change value of Y-axis inclination.

In this case, when the declination angles (w1 and w2) are equal to each other, the first rotation angle (θ₁) and the second rotation angle (θ₂) may have one value, and when the declination angles (ω1 and ω2) are different from each other, the first rotation angle (θ₁) and the second rotation angle (θ₂) may have two pairs of values.

The mathematical formulas (1) and (2) may be applied when 0°, which is a positive direction of an X-axis, is set as a reference axis of the phase of the first wheel 110, as in FIG. 7A, and the second wheel 120 has a phase difference of 180° from the first wheel 110, as in FIG. 7B. Conversely, when the positive direction of the X-axis, 0°, is set as a reference axis for the phase of the second wheel 120, and the first wheel 110 has a phase difference of 180° from the second wheel 120, the first rotation angle (θ₁) and the second rotation angle (θ₂) may be calculated by the following mathematical formulas (1-1) and (2-1).

$$C 1 = - ω1 \cdot cos {θ}_{1} - ω2 \cdot cos {θ}_{2} \qquad Mathematical formula ( 1 - 1 )$$

$$C 2 = ω1 \cdot sin {θ}_{1} + ω2 \cdot sin {θ}_{2} \qquad Mathematical formula ( 2 - 1 )$$

where θ₁ refers to a first rotation angle, θ₂ refers to a second rotation angle, ω1 refers to a declination angle of a first wheel, ω2 refers to a declination angle of a second wheel, C1 refers to a change value of X-axis inclination, and C2 refers to a change value of Y-axis inclination. This is nothing more than a change in sign depending on a reference position.

Meanwhile, using the mathematical formulas (1) and (2), a range of the change value C1 of the X-axis inclination and the change value C2 of the Y-axis inclination of the rotating cylinder may be calculated by the first declination angle (w1) and the second declination angle (w2). More specifically, when the mathematical formulas (1) and (2) are squared and added, C1²+C2² may be expressed by the following mathematical formula (a).

$$C {1}^{2} + C {2}^{2} = {ω1}^{2} + {ω2}^{2} + 2 ω1ω2 \cdot cos ( {θ}_{1} - {θ}_{2} ) \qquad Mathematical formula ( a )$$

where θ₁ refers to a first rotation angle, θ₂ refers to a second rotation angle, ω1 refers to a declination angle of a first wheel, ω2 refers to a declination angle of a second wheel, C1 refers to a change value of X-axis inclination, and C2 refers to a change value of Y-axis inclination.

In this case, since a value of cos(θ1−θ₂) is determined from −1 to +1, the range of the change value C1 of the X-axis inclination of the rotating cylinder and the change value C2 of the Y-axis inclination thereof may be calculated by the following mathematical formula (3).

$${( ω1 - ω2 )}^{2} \leq C {1}^{2} + C {2}^{2} \leq {( ω1 + ω2 )}^{2} \qquad Mathematical formula ( 3 )$$

where ω1 refers to a declination angle of a first wheel, ω2 refers to a declination angle of a second wheel, C1 refers to a change value of X-axis inclination, and C2 refers to a change value of Y-axis inclination.

For example, if the first declination angle (w1) of the first wheel 110 is 5°, the second declination angle (w2) of the second wheel 120 is 10°, and the target change value of Y-axis inclination of the rotating cylinder 100 is 0°, the range of the target change value of X-axis inclination of the rotating cylinder 100 may be 5° to 15°.

Furthermore, in the first rotation operation (S20) according to an embodiment of the present disclosure, the first wheel 110 and the second wheel 120 may be rotated simultaneously, and rotation speeds (v₁ and v₂) of the first wheel 110 and the second wheel 120 may be calculated by the following mathematical formula (4).

$${v}_{1} = \frac{{θ}_{1}}{t} , {v}_{2} = \frac{{θ}_{2}}{t} \qquad Mathematical formula ( 4 )$$

where v₁ refers to a rotation speed of a first wheel, v₂ refers to a rotation speed of a second wheel, θ₁ refers to a first rotation angle, θ₂ refers to a second rotation angle, and t refers to a pre-set rotation time.

Accordingly, the control method of the rotating cylinder according to an embodiment of the present disclosure may control the first wheel 110 and the second wheel 120 to start rotating at the same time, and stop the rotation at the same time.

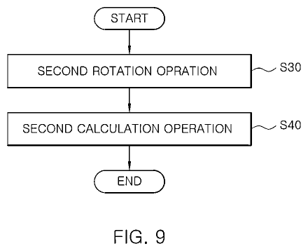

Meanwhile, FIG. 9 is a flowchart of a control method of a rotating cylinder according to a second embodiment of the present disclosure, and the method for controlling a rotating cylinder according to a second embodiment of the present disclosure can control the rotating cylinder according to an embodiment of the present disclosure illustrated in FIG. 5. Hereinafter, a control method of a rotating cylinder according to a second embodiment of the present disclosure will be described with reference to FIGS. 5 and 9.

The control method of the rotating cylinder according to a second embodiment of the present disclosure includes a second rotation operation (S30) and a second calculation operation (S40). In this case, in the second rotation operation (S30), the first wheel 100 may be rotated in the first direction by a first rotation angle (θ₁), which is a pre-set rotation angle of the first wheel 110, and the second wheel 120 may be rotated in the first direction by a second rotation angel (θ₂), which is a pre-set rotation angle of the second wheel 120.

In the second calculation operation (S40), by setting a virtual X-axis and a virtual Y-axis, which are orthogonal coordinate systems, on the rotating cylinder 100, and inputting the first rotation angle (θ₁) and the second rotation angle (θ₂), change values of the X-axis and Y-axis inclinations of the rotating cylinder 100 may be calculated. In this case, the centers of rotation of the first wheel 110 and the second wheel 120 may be the same. In the second calculation operation (S40), like the first calculation operation (S10), a relationship between the change value C1 of the X-axis inclination and the change value C2 of the Y-axis inclination may be applied to a trigonometric function. More specifically, in the second calculation operation (S40), the change value C1 of the X-axis inclination and the change value C2 of the Y-axis inclination according to a pre-set rotation angle (θ₁) and second rotation angle (θ₂) may be calculated by the following mathematical formulas (1) and (2). That is, in the second calculation operation (S40), since the first rotation angle (θ₁), the second rotation angle (θ₂), w1, and w2 are constants, the change value C1 of the X-axis inclination and the change value C2 of the Y-axis inclination may be calculated by the following mathematical formulas (1) and (2).

$$C 1 = ω1 \cdot cos {θ}_{1} + ω2 \cdot cos {θ}_{2} \qquad Mathematical formula ( 1 )$$

$$C 2 = ω1 \cdot sin {θ}_{1} + ω2 \cdot sin {θ}_{2} \qquad Mathematical formula ( 2 )$$

where θ₁ refers to a first rotation angle, θ₂ refers to a second rotation angle, ω1 refers to a declination angle of a first wheel, ω2 refers to a declination angle of a second wheel, C1 refers to a change value of X-axis inclination, and C2 refers to a change value of Y-axis inclination.

That is, unlike the control method of the rotating cylinder according to the first embodiment of the present disclosure which calculates a first rotation angle (θ₁) and a second rotation angle (θ₂) by using the change value C1 of the X-axis inclination and the change value C2 of the Y-axis inclination, in a control method of a rotating cylinder according to a second embodiment of the present disclosure, a change value C1 of X-axis inclination and a change value C2 of Y-axis inclination may be calculated using the first rotation angle (θ₁) and the second rotation angle (θ₂).

Therefore, according to the control method of the rotating cylinder according to the first and second embodiments of the present disclosure, in controlling the rotating cylinder 100 according to an embodiment of the present disclosure, a relationship between the rotation angles θ₁ and θ₂ of the first wheel 110 and the second wheel 120 and the change value C1 of the X-axis inclination and the change value C2 of the Y-axis inclination of the rotating cylinder 100 may be calculated by applying a trigonometric function. In addition, the control method of the rotating cylinder according to the first and second embodiments of the present disclosure may have a high degree of durability even under high loads when controlling a surface contact point of the rotary cylinder 100, so that it can be widely applied to robot arms, or the like, and precise control and horizontal alignment may be easily performed.

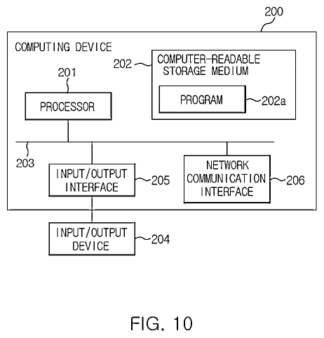

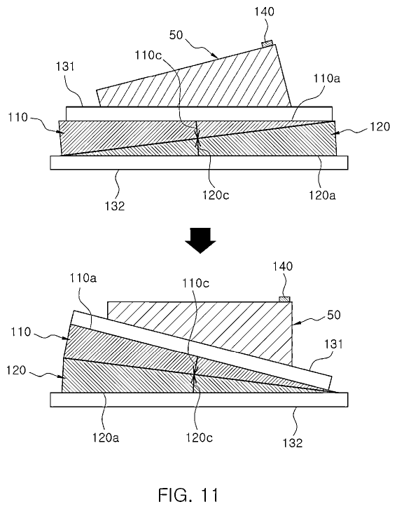

FIG. 10 and FIG. 11 are drawings for illustrating a control device of a rotating cylinder according to an embodiment of the present disclosure. More specifically, FIG. 10 may be a block diagram of a computing device 200 that can fully or partially implement a control device of a rotating cylinder according to an embodiment of the present disclosure, and FIG. 11 may be a usage state diagram of a control device of a rotating cylinder according to an embodiment of the present disclosure. Meanwhile, the control method of the rotating cylinder according to an embodiment of the present disclosure described above may be performed by the computing device 200 illustrated in FIG. 10. Hereinafter, the control device of the rotating cylinder according to an embodiment of the present disclosure will be described with reference to FIG. 5, FIG. 10, and FIG. 11.

As illustrated in FIG. 10, the computing device 200 includes at least one processor 201, a computer-readable storage medium 202, and a communication bus 203.

The processor 201 may cause the computing device 200 to operate according to the above-described exemplary embodiments. For example, the processor 201 may execute one or more programs store in the computer-readable storage medium 202. The one or more programs may include one or more computer executable instructions, wherein, when executed by the processor 201, the computer-readable executable instructions may be configured to cause the computing device 200 to perform operations according to an exemplary embodiment.

The computer-readable storage medium 202 is configured to store computer-executable instructions or program code, program data, and/or other suitable forms of information. A program 202a stored on the computer-readable storage medium 202 includes a set of instructions executable by the processor 201. In an embodiment, the computer-readable storage medium 202 may include a memory (a volatile memory such as a random access memory, a non-volatile memory, or a suitable combination thereof), one or more magnetic disk storage devices, optical disk storage devices, flash memory devices, other forms of storage media that can be accessed by the computing device 200 and store desired information, or suitable combinations thereof.

The communication bus 203 interconnects various other components of the computing device 200, including the processor 201 and the computer-readable storage medium 202.

The computing device 200 may also include one or more input/output interfaces 205 and one or more network communication interfaces 206 providing an interface for one or more input/output devices 204. The input/output interface 205 and the network communication interface 206 are connected to the communication bus 203.

The input/output device 204 may be connected to other components of the computing device 200 through the input/output interface 205. The exemplary input/output device 204 may include an input device such as a pointing device (a mouse, a trackpad, or the like), a keyboard, a touch input device (a touchpad, a touchscreen, or the like), a voice or sound input device, various types of sensor devices, and/or a photographing device, and an output device such as a display device, a printer, a speaker, and/or a network card. The exemplary input/output device 204 may be included inside the computing device 200 as a component constituting the computing device 200, or may be connected to the computing device 200 as a separate device, distinct from the computing device 200.

The control device of the rotating cylinder according to an embodiment of the present disclosure includes a memory storing commands and a processor 201 which operates by executing the commands, the processor 201 may set a virtual X-axis and a virtual Y-axis, which are orthogonal coordinate systems, on the rotating cylinder 100, input change values C1 and C2 of the X-axis and Y-axis inclinations of the rotating cylinder 100, to calculate rotation angles θ₁ and θ₂ of the first wheel 110 and the second wheel 120, and the first wheel 110 may be rotated in the first direction by a first rotation angle θ₁, the calculated rotation angle of the first wheel 110, and the second wheel 120 may be rotated in the first direction by a second rotation angle θ₂, the rotation angle of the second wheel 120. In this case, the centers of rotation of the first wheel 110 and the second wheel 120 may be the same.

Furthermore, the control device of the rotating cylinder according to an embodiment of the present disclosure, in the process in which the processor 201 calculates rotation angles θ₁ and θ₂ of the first wheel 110 and the second wheel 120, a relationship of a change value of X-axis inclination C1 and a change value of Y-axis inclination C2 may be applied to a trigonometric function. More specifically, since the X-axis and Y-axis have a difference of 90°, the change value C1 of the X-axis inclination may be obtained by applying a cosine function to a declination angle w1 of the first wheel 110, and the change value C2 of the Y-axis inclination may obtained by applying a sine function to a declination angle w2 of the second wheel 120.

The control device of the rotating cylinder according to an embodiment of the present disclosure may perform a first calculation operation (S10) according to the embodiment of the present disclosure described above, and more specifically, the processor 201 may calculate the first rotation angle (θ₁) and the second rotation angle (θ₂) by using the change value C1 of the X-axis inclination and the change value C2 of the Y-axis inclination of the pre-set rotating cylinder by the following mathematical formulas (1) and (2).

$$C 1 = ω1 \cdot cos {θ}_{1} + ω2 \cdot cos {θ}_{2} \qquad Mathematical formula ( 1 )$$

$$C 2 = ω1 \cdot sin {θ}_{1} + ω2 \cdot sin {θ}_{2} \qquad Mathematical formula ( 2 )$$

where θ₁ refers to a first rotation angle, θ₂ refers to a second rotation angle, ω1 refers to a declination angle of a first wheel, ω2 refers to a declination angle of a second wheel, C1 refers to a change value of X-axis inclination, and C2 refers to a change value of Y-axis inclination.

Furthermore, the processor 201 may rotate the first wheel 110 and the second wheel 120 simultaneously, and may calculate rotation speeds (v₁ and v₂) of the first wheel 110 and the second wheel 120 by the following mathematical formula (4).

$${v}_{1} = \frac{{θ}_{1}}{t} , {v}_{2} = \frac{{θ}_{2}}{t} \qquad Mathematical formula ( 4 )$$

where v₁ refers to a rotation speed of the first wheel, v₂ refers to a rotation speed of the second wheel, θ₁ refers to a first rotation angle, θ₂ refers to a second rotation angle, and t refers to a pre-set rotation time.

The control device of the rotating cylinder according to an embodiment of the present disclosure may include a first base plate 131 provided on a base surface 110a of the first wheel 110 and a second base plate 132 provided on a base surface 120a of the second wheel 120, the first and second base plates 131 and 132 may be provided so as not to rotate according to the rotation of the first wheel 110 and the second wheel 120, and the first base plate 131 may have an inclination according to a change in X-axis and Y-axis inclinations of the rotating cylinder 100.

Furthermore, the control device of the rotating cylinder according to an embodiment of the present disclosure may further include an inclination sensor 140 for measuring an X-axis inclination and a Y-axis inclination of an object to be detected 50 disposed on the first base plate 131. In this case, the processor 201 may input compensation values C3 and C4 of the X-axis inclination and the Y-axis inclination of the object to be detected 50 measured by the inclination sensor 140, in the process of inputting the change values C1 and C2 of the X-axis and Y-axis inclinations, and may rotate the first wheel 110 and the second wheel 120 by the rotation angles θ₁ and θ₂ of the first wheel 110 and the second wheel 120 calculated based on the compensation values C3 and C4 of the X-axis inclination and the Y-axis inclination of the object to be detected 50.

For example, as illustrated in FIG. 11, the inclination sensor 140 may measure that the X-axis inclination of the object to be detected object 50 is 40° and the Y-axis inclination thereof is −5°. The processor 201 may rotate the first wheel 110 and the second wheel 120 by the rotation angles θ₁ and θ₂ of the first wheel 110 and the second wheel 120 calculated by inputting −40° to the compensation value C3 of the X-axis inclination and +5° to the compensation value C4 of the Y-axis inclination. Accordingly, the control device of the rotating cylinder according to an embodiment of the present disclosure may align the rotating cylinder 100 horizontally, and further, if an initial state has an X-axis inclination and a Y-axis inclination, the control device can return it to the initial state.

Therefore, the control device of the rotating cylinder according to an embodiment of the present disclosure may have a high degree of durability even under high loads when controlling a surface contact point of the rotating cylinder 100, and thus may be widely applied to robot arms, or the like, and precise control and horizontal alignment may be easily performed. Furthermore, the control device of the rotating cylinder may rotate the first wheel 110 and the second wheel 120 so that an object disposed above the first base plate 131 has a desired inclination, and can accurately calculate a position of one end of the object. In addition, the object disposed above the first base plate 131 may move conically within a predetermined angle based on the center of rotation.

As set forth above, according to an embodiment of the present disclosure, it is possible to provide a control method and a control device of two obliquely cut rotating cylinders that can measure X-axis and Y-axis inclinations of a rotating cylinder composed of two rotating first and second wheels and declination angles of the first wheel and the second wheel thereof and calculate rotation angles of the first wheel and second wheel according to the inclination and the declination angle by applying trigonometric function calculation.

In addition, according to an embodiment, it is possible to calculate the change values of the X-axis and Y-axis inclinations of the rotating cylinder according to the rotation angles of the first wheel and the second wheel.

In addition, according to an embodiment, by attaching an inclination sensor, or the like to a rotating cylinder, X-axis and Y-axis inclinations may be easily measured, and by using the measured X-axis and Y-axis inclinations, the rotating cylinder may be tilted to a desired inclination as well as horizontally aligned.

The present disclosure is not limited to the above-described embodiments and the accompanying drawings but is defined by the appended claims. Therefore, those of ordinary skill in the art may make various replacements, modifications, or changes without departing from the scope of the present disclosure defined by the appended claims, and these replacements, modifications, or changes would be obvious to those of ordinary skill in the art.

What is claimed is:

1. A control method of a rotating cylinder, comprising:
a first calculation operation of setting a virtual X-axis and a virtual Y-axis, which are orthogonal coordinate systems, on a rotating cylinder including a first wheel and a second wheel, which are disposed so that inclined surfaces forming a declination angle with respect to each of base surfaces are in contact with each other, and calculating rotation angles of the first wheel and the second wheel by inputting a target change value of X-axis and Y-axis inclinations of the rotating cylinder, and
a first rotation operation of rotating the first wheel by a first rotation angle, which is a rotation angle of the first wheel calculated in the first calculation operation, around a first rotation axis directed from a base surface of the first wheel to a center of rotation, and rotating the second wheel by a second rotation angle, which is a rotation angle of the second wheel, around a second rotation axis directed from a base surface of the second wheel to a center of rotation,
wherein the centers of rotation of the first and second wheels are the same.

2. The control method of the rotating cylinder of claim 1, wherein, in the first calculation operation, a relationship between the change value of the X-axis inclination of the rotating cylinder and the change value of the Y-axis inclination of the rotating cylinder is applied to a trigonometric function.

3. The control method of the rotating cylinder of claim 2, wherein the change value of the X-axis inclination of the rotating cylinder is the sum of the change value of the X-axis inclination of the first wheel and the change value of the X-axis inclination of the second wheel, and
the change value of the Y-axis inclination of the rotating cylinder is the sum of the change value of the Y-axis inclination of the first wheel and the change value of the Y-axis inclination of the second wheel.

4. The control method of the rotating cylinder of claim 3, wherein, in the first calculation operation, the first rotation angle and the second rotation angle according to the change value of the X-axis inclination and the change value of the Y-axis inclination of the rotating cylinder are calculated by the following mathematical formulas (1) and (2),
$$C 1 = ω1 \cdot cos {θ}_{1} + ω2 \cdot cos {θ}_{2} \qquad Mathematical formula ( 1 )$$
$$C 2 = ω1 \cdot sin {θ}_{1} + ω2 \cdot sin {θ}_{2} \qquad Mathematical formula ( 2 )$$
where θ₁ refers to a first rotation angle, θ₂ refers to a second rotation angle, ω1 refers to a declination angle of a first wheel, ω2 refers to declination of a second wheel, C1 refers to a change value of X-axis inclination, and C2 refers to a change value of Y-axis inclination.

5. The control method of the rotating cylinder of claim 4, wherein, in the first calculation operation, a range of the change value of the X-axis inclination and the change value of the Y-axis inclination of the rotating cylinder is calculated by the following mathematical formula (3),
$${( ω1 - ω2 )}^{2} \leq C {1}^{2} + C {2}^{2} \leq {( ω1 + ω2 )}^{2} \qquad Mathematical formula ( 3 )$$
where ω1 refers to a declination angle of a first wheel, ω2 refers to a declination angle of a second wheel, C1 refers to a change value of X-axis inclination, and C2 refers to a change value of Y-axis inclination.

6. The control method of the rotating cylinder of claim 4, wherein, in the first rotation operation,
the first wheel and the second wheel are rotated simultaneously, and
rotation speeds of the first wheel and the second wheel are calculated by the following mathematical formula (4),
$${v}_{1} = \frac{{θ}_{1}}{t} , {v}_{2} = \frac{{θ}_{2}}{t} \qquad Mathematical formula ( 4 )$$
where v₁ refers to a rotation speed of a first wheel, v₂ refers to a rotation speed of a second wheel, θ₁ refers to a first rotation angle, θ₂ refers to a second rotation angle, and t means a pre-set rotation time.

7. A control method of a rotating cylinder, comprising:
a second rotation operation of rotating a first wheel and a second wheel disposed so that inclined surfaces forming a declination angle with respect to each of base surfaces are in contact with each other, rotating the first wheel by a first rotation angle, which is a pre-set rotation angle of the first wheel, around a first rotation axis directed from a base surface of the first wheel to a center of rotation, and rotating the second wheel by a second rotation angle, which is a pre-set rotation angle of the second wheel, around a second rotation axis directed from a base surface of the second wheel to a center of rotation; and
a second calculation operation of setting a virtual X-axis and a virtual Y-axis, which are orthogonal coordinate systems, on the rotating cylinder, and calculating change values of X-axis and Y-axis inclinations of the rotating cylinder by inputting the first rotation angle and the second rotation angle,
wherein the centers of rotation of the first wheel and the second wheel are the same.

8. The control method of the rotating cylinder of claim 7, wherein, in the second calculation operation, a relationship between the change value of the X-axis inclination and the change value of the Y-axis inclination is applied to a trigonometric function.

9. The control method of the rotating cylinder of claim 8, wherein, in the second calculation operation, the change value of the X-axis inclination and the change value of the Y-axis inclination according to the pre-set first rotation angle and second rotation angle are calculated by the following mathematical formulas (1) and (2),
$$C 1 = ω1 \cdot cos {θ}_{1} + ω2 \cdot cos {θ}_{2} \qquad Mathematical formula ( 1 )$$
$$C 2 = ω1 \cdot sin {θ}_{1} + ω2 \cdot sin {θ}_{2} \qquad Mathematical formula ( 2 )$$
where θ₁ refers to a first rotation angle, θ₂ refers to a second rotation angle, ω1 refers to a declination angle of a first wheel, ω2 refers to a declination angle of a second wheel, C1 refers to a change value of X-axis inclination, and C2 refers to a change value of Y-axis inclination.

10. In a control device of a rotating cylinder including a first wheel and a second wheel disposed so that inclined surfaces forming a declination angle with respect to each of base surfaces are in contact with each other,
wherein the control device of the rotating cylinder, comprises:
a memory storing commands; and
a processor operating by executing the commands,
wherein the processor sets virtual X-axis and Y-axis, which are orthogonal coordinate systems, on the rotating cylinder, and calculates rotation angles of the first wheel and the second wheel by inputting target change values of X-axis and Y-axis inclinations of the rotating cylinder,
rotates the first wheel in a clockwise direction by a first rotation angle, the calculated rotation angle of the first wheel, and rotates the second wheel in the clockwise direction by a second rotation angle, the rotation angle of the second wheel,
wherein the centers of rotation of the first wheel and the second wheel are the same.

11. The control device of the rotating cylinder of claim 10, wherein the processor, in the process of calculating the rotation angles of the first wheel and the second wheel, a relationship between the change value of the X-axis inclination and the change value of the Y-axis inclination is applied to a trigonometric function.

12. The control device of the rotating cylinder of claim 11, wherein the processor calculates the first rotation angle and the second rotation angle using the pre-set change value of the X-axis inclination and the change value of the Y-axis inclination of the rotating cylinder by the following mathematical formulas (1) and (2),
$$C 1 = ω1 \cdot cos {θ}_{1} + ω2 \cdot cos {θ}_{2} \qquad Mathematical formula ( 1 )$$
$$C 2 = ω1 \cdot sin {θ}_{1} + ω2 \cdot sin {θ}_{2} \qquad Mathematical formula ( 2 )$$
where θ₁ refers to a first rotation angle, θ₂ refers to a second rotation angle, ω1 refers to a declination angle of a first wheel, ω2 refers to a declination angle of a second wheel, C1 refers to a change value of X-axis inclination, C2 refers to a change value of Y-axis inclination.

13. The control device of the rotating cylinder of claim 12, wherein the control device of the rotating cylinder comprises
a first base plate provided on a base surface of the first wheel; and
a second base plate provided on a base surface of the second wheel,
wherein the first base plate has an inclination according to the change value of the X-axis inclination and the change value of the Y-axis inclination of the rotating cylinder.

14. The control device of the rotating cylinder of claim 13, further comprising:
an inclination sensor for measuring an X-axis inclination and a Y-axis inclination of an object to be detected disposed on the first base plate,
wherein the processor, in the process of inputting the change values of the X-axis and Y-axis inclinations, inputs compensation values of the X-axis inclination and the Y-axis inclination of the object to be detected measured by the inclination sensor, and
rotates the first wheel and the second wheel by the rotation angles of the first wheel and the second wheel calculated according to the compensation values of the X-axis inclination and the Y-axis inclination of the object to be detected.

15. The control device of the rotating cylinder of claim 14, wherein the rotating cylinder has a phase difference between the first wheel and the second wheel of 180°.
